(19) United States
(12) Patent Application Publication
(10) Pub. No.: US 2021/0022538 A1
(43) Pub. Date: Jan. 28, 2021

(54) INDUCTION VESSEL

(71) Applicant: Karl Ingar Kittelsen Røberg, Oslo (NO)

(72) Inventor: Karl Ingar Kittelsen Røberg, Oslo (NO)

(21) Appl. No.: 17/064,615

(22) Filed: Oct. 7, 2020

Related U.S. Application Data
(60) Provisional application No. 62/911,654, filed on Oct. 7, 2019.

(51) Int. Cl. A47J 27/00; H05B 6/12; A47J 36/02

(52) U.S. Cl. CPC A47J 27/002; A47J 36/02; H05B 6/1209

(57) ABSTRACT

A cooking and tableware vessel having a double-layered wall structure which preserves heat entrapped during cooking has been disclosed herein. The present invention discloses a unique design of a cooking and tableware vessel that can be used as a cookware and a tableware and is compatible with induction cooking. The disclosed vessel is the first to blend the cooking abilities of a cookware with the easy handling of a tableware. Thus, a new type of cooking and tableware vessel can be constructed that can greatly improve the cooking experience when using an induction top. Because of its tableware design, this new design of cooking and tableware vessel may also be constructed to incorporate design technology of food containers and thus become a type of cooking and tableware vessel that incorporate the benefits of tableware, cookware, and food containers.

### CROSS-REFERENCE TO RELATED PATENT DOCUMENTS

This patent application claims the benefit of priority of U.S. Provisional Application No. 62/911,654, entitled “Induction vessel”, and filed on Oct. 7, 2019, which is hereby incorporated herein by reference in its entirety.

### FIELD OF THE INVENTION

The present disclosure generally relates to a cooking utensil, and particularly, to a cooking utensil having a double-layered wall structure which preserves heat entrapped during cooking. More particularly, the present invention is in the technical field of cookware and tableware. More particularly, the present invention is in the technical field of cookware and tableware that are compatible with induction cooking.

### BACKGROUND

Various types of cooking utensil are known and used in a kitchen. Such cooking utensils are made of one or more layers of stainless steel and has a single-layered bottom. The single-layered bottom is good for directly transmitting heat to the food contained in a utensil, but also causes burning of the food when carefully not attended to. To solve the above problems, a cooking utensil having a double-layered structure have been previously presented and such utensil may be useful in preventing burnt food. However, with such utensils, the outer surface still heats up during the cooking process and may not be desirable and effective for many users. Now-a-days, induction cooking is becoming quite famous and are adopted by a large part of the residential and commercial segment for preparing food. In induction cooking, a current in an induction coil produces a magnetic field. This magnetic field induces flow of current in a conductive target that is a part of a cookware. The induced current flow causes the target to heat. The heat is transferred to the cooking surface for heating or cooking food or other items kept on the cooking surface of the cookware. Heat from the target is also transferred to the outer surface of the cookware, which creates a safety issue and can make the cookware too hot to handle or place on a tabletop or other heat-sensitive surface. Heating of the outer surface of the cookware also causes the cooktop to be heated, which can present its own safety issues. Further, the use of specialized cookware on the induction top means that energy and time is wasted when food and hot liquids is transferred from the cookware to tableware or drinkware. There are quite few solutions that try to solve the above-mentioned problems but fail to achieve to desired efficiency and effectiveness. Further, the current solutions do not offer a method for producing a cookware and tableware that are compatible with an induction cooktop using common tableware materials.

U.S. Pat. No. 8,395,098 (entitled “Induction cookware”) discloses an induction cookware comprising a cooking body having a bottom and a periphery wall extended upwardly from the periphery of said bottom, wherein said bottom and said periphery wall formed a containing groove; an inner pot disposed in said containing groove; an electric heating tube disposed in said containing groove, said electric heating tube fixedly connected to said inner pot; and an induction coil disposed in the bottom of said cooking body, and said induction coil electrically connected to the electric heating tube.

U.S. Pat. Pub. No. 20090065496 (entitled “Induction cookware”) discloses an induction cooking utensil that is constructed such that it cooks food within its chamber while maintaining a relatively cool outer surface (e.g., preferably an outer surface that is cool enough to pick up with one's bare hands). The cooking utensil includes an inner wall that is made at least in part of an electrically conductive material and an outer wall that is made at least in part of the electrically non-conductive material. A reflective layer is disposed between the inner and outer walls to reflect radiant heat away from the outer wall.

U.S. Pat. Pub. No. 20120037615 (entitled “Induction Cookware for Keeping Food Warm”) discloses a ferromagnetic material on the base of an item of induction cookware is divided into fields by interruptions, the fields being limited to sub-areas of the base. Electrical eddy currents, which are generated by an alternating magnetic field of an induction transmitter, cannot continue beyond the interruptions in the ferromagnetic material, but rather are limited to the fields. The electrical eddy currents are limited to the fields of ferromagnetic material in areas that are smaller than the base of the induction cookware, which results in a more even distribution of heat to the surface of the base of the induction cookware and which prevents the breaking or rupturing of the induction cookware or at least reduces the risk of the breaking or rupturing of the induction cookware. The invention is provided in particular for induction cookware with large bases, in which the risk of stress cracks is high.

The foregoing approaches for alleviating the problem of the cooking utensils leave much to be desired, since these designs offer little in the way of comfort or convenience for the many users. In addition, none of these utensils prevent the heating of the outer surface and hence are not effective and efficient as per the user's preferences. It should be obvious that such utensils are neither comfortable nor efficient in resolving the problems imposed by the conventional utensils. Thus, there is a need for an improved cooking utensil that can be used as cookware and tableware and is compatible with induction cooking.

### SUMMARY

It will be understood that this disclosure is not limited to the particular induction vessel described herein, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

It is an objective of the present invention to provide a cooking and tableware vessel having a double-layered wall structure which preserves heat entrapped during cooking. The present invention discloses a unique design of a cooking and tableware vessel that can be used as a cookware and a tableware and is compatible with induction cooking. The disclosed vessel is the first to blend the cooking abilities of a cookware with the easy handling of a tableware. Thus, a new type of cooking and tableware vessel can be constructed that can greatly improve the cooking experience when using an induction top. Because of its tableware design, this new design of cooking and tableware vessel may also be constructed to incorporate design technology of food containers and thus become a type of cooking and tableware vessel that incorporate the benefits of tableware, cookware, and food containers. Since the disclosed cooking and tableware vessel contains the heat from the cooking surface to a specific part of the cooking and tableware vessel, it opens up the possibility to incorporate heat sensitive components directly in the cooking and tableware vessel. Finally, the new class of cooking and tableware vessels may make it possible to expand the design and material choices of induction cooktops, thus not only improving the cooking and eating experience, but also opening up for new development within induction cooktop technology.

The present invention discloses a unique design of a cooking and tableware vessel that can be used for preparing food on an induction cooking top while keeping an outside surface of the cooking and tableware vessel from heating up. The same cooking and tableware vessel is also made so that food can be consumed directly from the cooking and tableware vessel. The disclosed cooking and tableware vessel employs several materials in a layered structured to provide an outer surface that is cold from outside and an inner surface that is warm from inside in cookware and tableware. A layer of conductive material provides a layer for the inducement of eddy currents, when exposed to a changing magnetic field, that due to resistance create heat in the cooking and tableware vessel. A layer of heat insulating non-conductive material provides a way of insulating the outside surface of the cooking and tableware vessel from the heated layer. This proposed approach provides the cooking and tableware vessel that can be warmed up on an induction top, while it still remains easy to handle along the outer surface where the user may be holding the cooking and tableware vessel. The ability to keep the outer surface of the cooking and tableware vessel cold through the cooking process makes it possible to lift it directly of the cooking top without any danger of burning the user's fingers. This cooking and tableware vessel may be easier to handle compared to the conventional cooking and tableware vessels that warm up from the outside as well. Further, the ability to keep the bottom of the cooking and tableware vessel from heating up will mean that it can be placed directly on any heat sensitive surface right after the cooking is finished. The design of the cooking and tableware vessel contains the heat of the cooking surface in such a way that it can protect the heat sensitive components that can be placed in various areas in or on the cooking and tableware vessel. It also opens up for using induction cooking tops that have a contact surface that is not heat resistant. And it reduces the danger of burns on a hot induction top after the cooking and tableware vessel is removed. Including a heating surface directly into a tableware, drinkware or container ware piece will further reduce the need for classical cookware after preparing the food. This saves energy and time. By way of the disclosed cooking and tableware vessel, it is therefore the primary purpose of this invention to provide new and improved thermally insulated cookware, tableware, and foot container for use with dynamic, high frequency, magnetic induction field cooking and heating apparatus, and the method for producing an embodiment of the current invention that makes it easy and relatively cheap to produce tableware and drinkware that are made of a typical tableware and drinkware material like glass, porcelain, earthware, stoneware, ceramic-glass, and similar material, while still resulting in a cooking and tableware vessel that incorporate the advantages of the present invention.

These and other features and advantages of the present invention will become apparent from the detailed description below, in light of the accompanying drawings.

### BRIEF DESCRIPTION OF ACCOMPANYING DRAWINGS

The present invention is illustratively shown and described in reference to the accompanying drawings, in which:

FIG. 1A is a diagram that illustrates a perspective view of a first cooking and tableware vessel, according to an exemplary embodiment of the present invention;

FIG. 1B is a diagram that illustrates a cross-sectional perspective view of the first cooking and tableware vessel taken along a line A-A of FIG. 1A, according to an exemplary embodiment of the present invention;

FIG. 2 is a diagram that illustrates a cross-sectional side view of the first cooking and tableware vessel of FIG. 1A, according to an exemplary embodiment of the present invention;

FIG. 3 is a diagram that illustrates a cross-sectional side view of a second cooking and tableware vessel, according to an exemplary embodiment of the present invention;

FIG. 4 is a diagram that illustrates a cross-sectional side view of a third cooking and tableware vessel, according to an exemplary embodiment of the present invention; and

FIG. 5 is a diagram that illustrates a cross-sectional side view of a fourth cooking and tableware vessel, according to an exemplary embodiment of the present invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a unique design of a cooking and tableware utensil or vessel having a double-layered wall structure which preserves heat entrapped during cooking. More particularly, the present invention is in the technical field of cookware and tableware that are compatible with induction cooking and keeps its outer surface cooler in comparison to its inner surface. Accordingly, the components have been represented, showing only specific details that are pertinent for an understanding of the present invention so as not to obscure the disclosure with details that will be readily apparent to those with ordinary skill in the art having the benefit of the description herein. As required, the detailed embodiments of the present invention are disclosed herein. However, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the present invention.

References to terms “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Unless stated otherwise, terms such as “first” and “second” are used to arbitrarily distinguish between the elements or entities. Thus, these terms are not necessarily intended to indicate temporal or other prioritization of such elements or priorities. While various exemplary embodiments of the disclosed induction vessel have been described below, a person having ordinary skills in the art would understand that the cooking and tableware vessel have been presented for purposes of example only, and not limitations. It is not exhaustive and does not limit the present invention to the precise form disclosed. Modifications and variations of the disclosed induction vessel are possible considering the below teachings or may be acquired from practicing of the present invention, without departing from the breadth or scope.

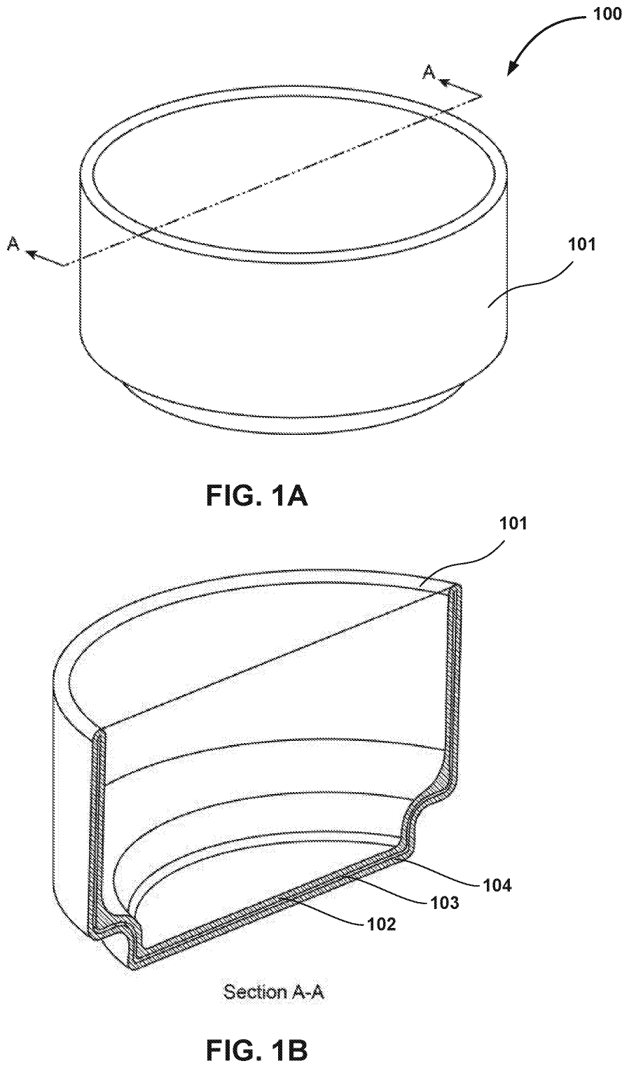

The cooking and tableware vessel of the present invention will now be described with reference to the accompanying drawings, particularly with respect to FIGS. 1-5.

FIG. 1A is a diagram 100 that illustrates a perspective view of a first cooking and tableware vessel 102, according to an exemplary embodiment of the present invention. The first cooking and tableware vessel 102 is a cookware bowl that can be used for cooking food and then can be used as a tableware bowl after the cooking. The first cooking and tableware vessel 102 is a thermally insulated vessel or utensil that is formed from an inner body layer of metal, or a non-metallic body layer with a conductive metal film, susceptible to being inductively heated with high frequency magnetic induction fields and at least one exterior body layer of thermally insulating material formed over substantially the entire exterior surface and comprising an insulating material that is substantially transparent to magnetic lines of flux. The inner metallic body layer or conductive metal film may comprise stainless steel, iron, titanium, porcelainized iron, gold, silver, copper, platinum, and the like, and the exterior insulating layer may be formed of a high temperature polyimid or polycarbonate plastic high temperature foam provided with an outer temperature-hardened surface of plastic, a ceramic, a high temperature glass, and the like. In certain embodiments, a window area is formed in the exterior insulating circuit (preferably at the bottom) which is transparent to infrared radiation and allows an infrared responsive temperature sensor to view the temperature of the inner metallic body layer for temperature sensing and temperature control purposes.

FIG. 1B is a diagram 100 that illustrates a cross-sectional perspective view of the first cooking and tableware vessel 101 taken along a line A-A of FIG. 1A, according to an exemplary embodiment of the present invention. In FIG. 1A, there is shown the first cooking and tableware vessel 101. The first cooking and tableware vessel 101 of FIG. 1A has been sliced along the line A-A to show the inside of the first cooking and tableware vessel 101 as shown in FIG. 1B. As shown, the first cooking and tableware vessel 101 comprises the inner body layer 102 and the exterior body layer 104. There is an insulating layer 103 between the inner body layer 102 and the exterior body layer 104. The inner body layer 102 is a conductive layer that is configured to be a target for an induction heating coil. The exterior body layer 104 is an insulating layer. To produce heating for the food placed in the first cooking and tableware vessel 101, the conductive layer 102 is present above the insulating layer 103. The conductive layer 102 may be made of metal such as steel, iron, titanium, porcelainized iron, silver, copper, platinum, gold, aluminium, or the like. The conductive layer 102 can either be applied on a structural material such as ceramics or glass, or it can itself make up the structural material of the inner layer that is in contact with the food. The insulating layer 103 is placed between the conductive layer 102 and the outer surface 104 of the first cooking and tableware vessel 101. The insulating layer 103 may be made of materials with low heat conductivity like vacuum, aerogel, ceramic foam, glass foam, cork, air, or similar materials. The insulating layer 103 can either be an outer structural material or layer for the first cooking and tableware vessel 101, or there can be added an outer structural material such as the outer body layer 104 such that the insulating layer 103 is between the inner body layer 102 and the outer body layer 104 of the first cooking and tableware vessel 101. The insulating layer 103 creates a difference in heat within the layered structure of the bowl, which opens up the possibility to incorporate heat sensitive components either in or on the inner body layer 102 or the outer body layer 104.

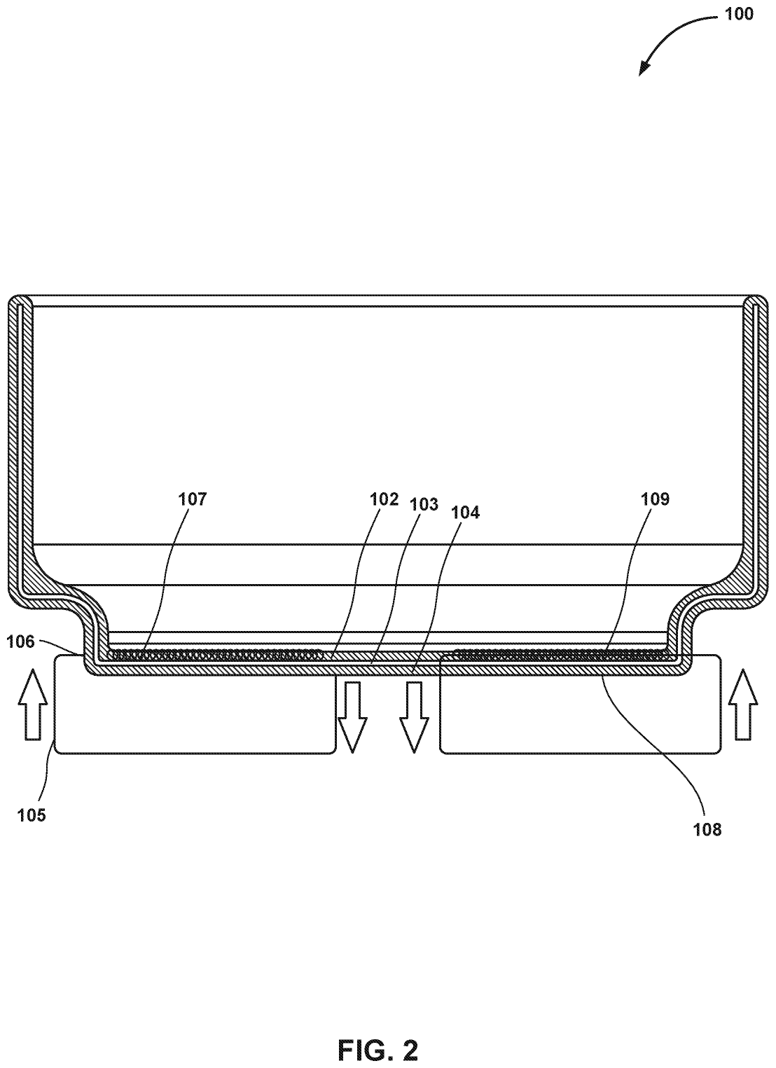

FIG. 2 is a diagram 100 that illustrates a cross-sectional side view of the first cooking and tableware vessel 101 of FIG. 1A, according to an exemplary embodiment of the present invention. In FIG. 2, the first cooking and tableware vessel 101 has been shown as it is subjected to a magnetic field 105. The magnetic field 105 quickly alternates which create eddy currents 107 in the conductive layer 102. The magnetic field 105 represents the type of magnetic field that is exerted by an induction top. The magnetic field 105 penetrates the outer body layer 104 and the insulating layer 103 as shown in the penetration point 106. As a result, there is a large temperature difference between a point on the outside 108 of the first cooking and tableware vessel 101 and a point on the inside 109 of the first cooking and tableware vessel 101. Hence, the inner body layer 102 is warmer than the outer body layer 104.

The type of cooking equipment for induction tops is no longer limited to the frying pans and pots and may extend into all types of tableware and containers for food and drinks. Examples include teapots, instant-food packaging, lunch boxes, mugs, plates, bowls, and thermos bottles. Thus, blurring the line between what can be thought of as cookware and what can be thought of as tableware and food container. Any food or drink container may become an easy to handle cooking and tableware vessel using the present invention. The advantages of the present invention may include, but are not limited to, a way of making cookware that is easy to handle by reducing the outer surface temperature so that it is not hot to touch in comparison to the inner surface temperature. The invention makes it possible to turn tableware into cookware by including an inductive surface in these types of vessels, without reducing the handling of these vessels. Further, by adding a lid, the first cooking and tableware vessel 101 has the ability to also serve as an efficient food container. Any cooking and tableware vessel incorporating the invention will be safe to place on any surface, thus extending the usefulness of these cooking and tableware vessels. The current invention also offers less risks of burning fingers when handling the cooking and tableware vessels. The invention also opens up the possibility to use materials that are less heat resistant when constructing induction cooktops since the cooking and tableware vessel does not generate any heat on the bottom facing down on the induction cooktop. The ability to create areas and surfaces within the cooking and tableware vessel that are insulated from the heat generated by the cooktop, makes it possible to include heat sensitive components. Examples of these components are electronics, measurement devices, and new forms of graphics expressions. Finally, the invention reduces the energy used by cooking, and extends the time the food is hot, by reducing the heat loss of the cooking and tableware vessel through the outer surface.

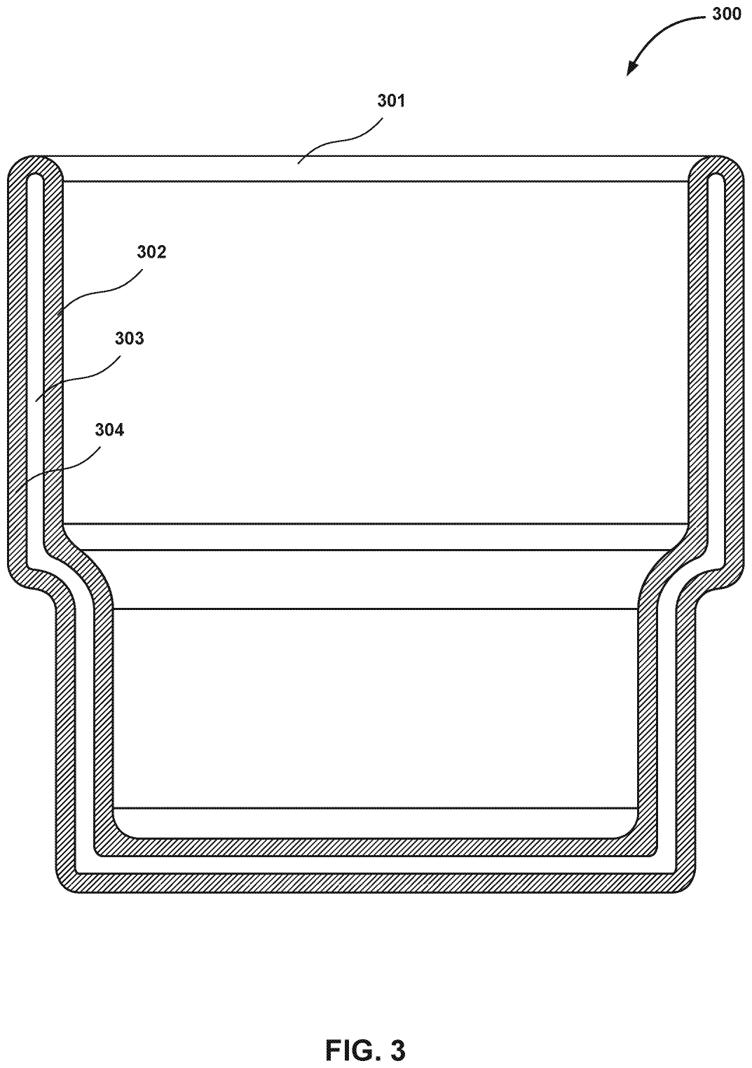

FIG. 3 is a diagram that illustrates a cross-sectional side view of a second cooking and tableware vessel 301, according to an exemplary embodiment of the present invention. In FIG. 3, the second cooking and tableware vessel 301 has been shown as a teacup. As shown, the second cooking and tableware vessel 301 comprises an inner body layer 302 and an exterior body layer 304. There is an insulating layer 303 between the inner body layer 302 and the exterior body layer 304. The inner body layer 302 is a conductive layer. The exterior body layer 304 is an insulating layer. To produce heating for the food placed in the second cooking and tableware vessel 301, the conductive layer 302 is present above the insulating layer 303. The conductive layer 302 may be made of metal such as steel, iron, titanium, porcelainized iron, silver, copper, platinum, gold, aluminium, or the like. The conductive layer 302 can either be applied on a structural material such as ceramics or glass, or it can itself make up the structural material of the inner layer that is in contact with the food. The insulating layer 303 is placed between the conductive layer 302 and the outer surface 304 of the second cooking and tableware vessel 301. The insulating layer 303 may be made of materials with low heat conductivity like vacuum, aerogel, ceramic foam, glass foam, cork, air, or similar materials. The insulating layer 303 can either be an outer structural material or layer for the second cooking and tableware vessel 301, or there can be added an outer structural material such as the outer body layer 304 such that the insulating layer 303 is between the inner body layer 302 and the outer body layer 304 of the second cooking and tableware vessel 301. The insulating layer 303 may create a difference in heat that opens up the possibility to incorporate heat sensitive components either in or on the inner body layer 302 or the outer body layer 304. The second cooking and tableware vessel 301 (i.e., a teacup) may be used for boiling water or milk. Further, after boiling the water or milk, the second cooking and tableware vessel 301 may be handled by a user like as any other cup since the outer body layer 304 is colder than the inner body layer 302. The teacup thus both functions as a small induction kettle and a cup.

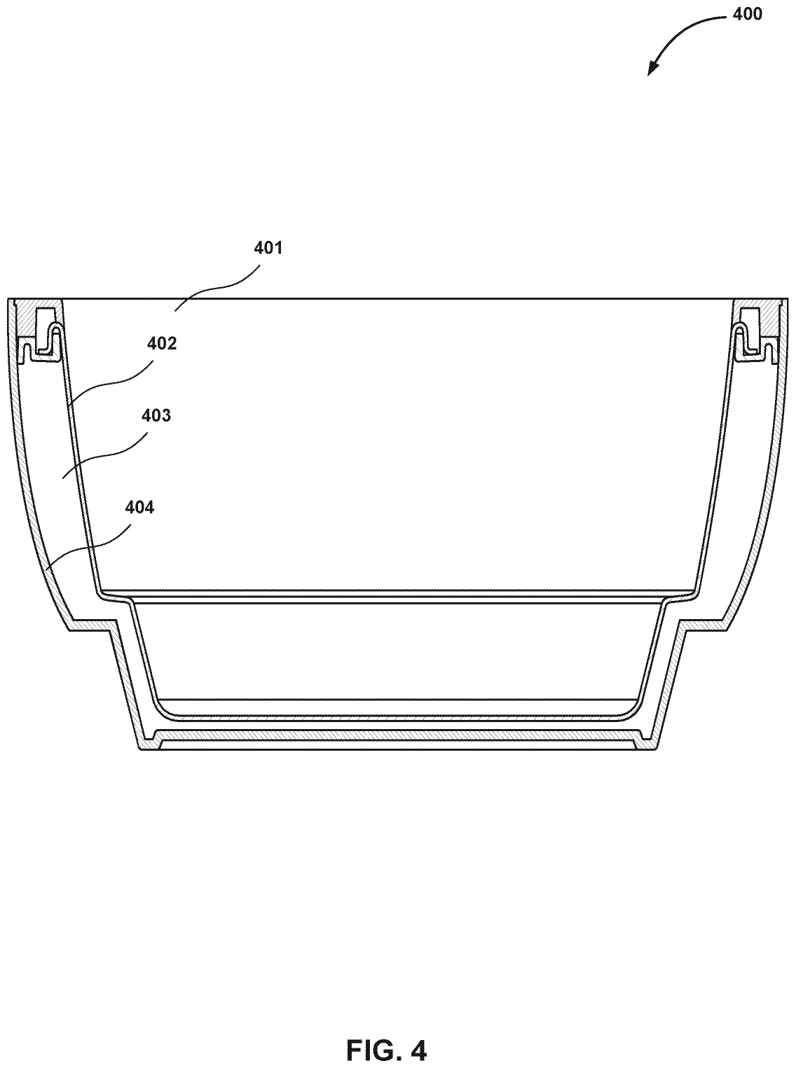

FIG. 4 is a diagram that illustrates a cross-sectional side view of a third cooking and tableware vessel 401, according to an exemplary embodiment of the present invention. As shown, the third cooking and tableware vessel 401 comprises an inner body layer 402 and an exterior body layer 404. There is an insulating layer 403 between the inner body layer 402 and the exterior body layer 404. The inner body layer 402 is a conductive layer. The exterior body layer 404 is an insulating layer. To produce heating for the food placed in the third cooking and tableware vessel 401, the conductive layer 402 is present above the insulating layer 403. The conductive layer 402 may be made of metal such as steel, iron, titanium, porcelainized iron, silver, copper, platinum, gold, aluminium, or the like. The conductive layer 402 can either be applied on a structural material such as ceramics or glass, or it can itself make up the structural material of the inner layer that is in contact with the food. The insulating layer 403 is placed between the conductive layer 402 and the outer surface 404 of the second cooking and tableware vessel 401. The insulating layer 403 may be made of materials with low heat conductivity like vacuum, aerogel, ceramic foam, glass foam, cork, air, or similar materials. The insulating layer 403 can either be an outer structural material or layer for the third cooking and tableware vessel 401, or there can be added an outer structural material such as the outer body layer 404 such that the insulating layer 403 is between the inner body layer 402 and the outer body layer 404 of the third cooking and tableware vessel 401. The insulating layer 403 may create a difference in heat that opens up the possibility to incorporate heat sensitive components either in or on the inner body layer 402 or the outer body layer 404. The third cooking and tableware vessel 401 (i.e., a bowl) may be used for cooking vegetables or rice. Further, after the cooking, the third cooking and tableware vessel 401 may be handled by a user like as any other tableware since the outer body layer 404 is colder than the inner body layer 402.

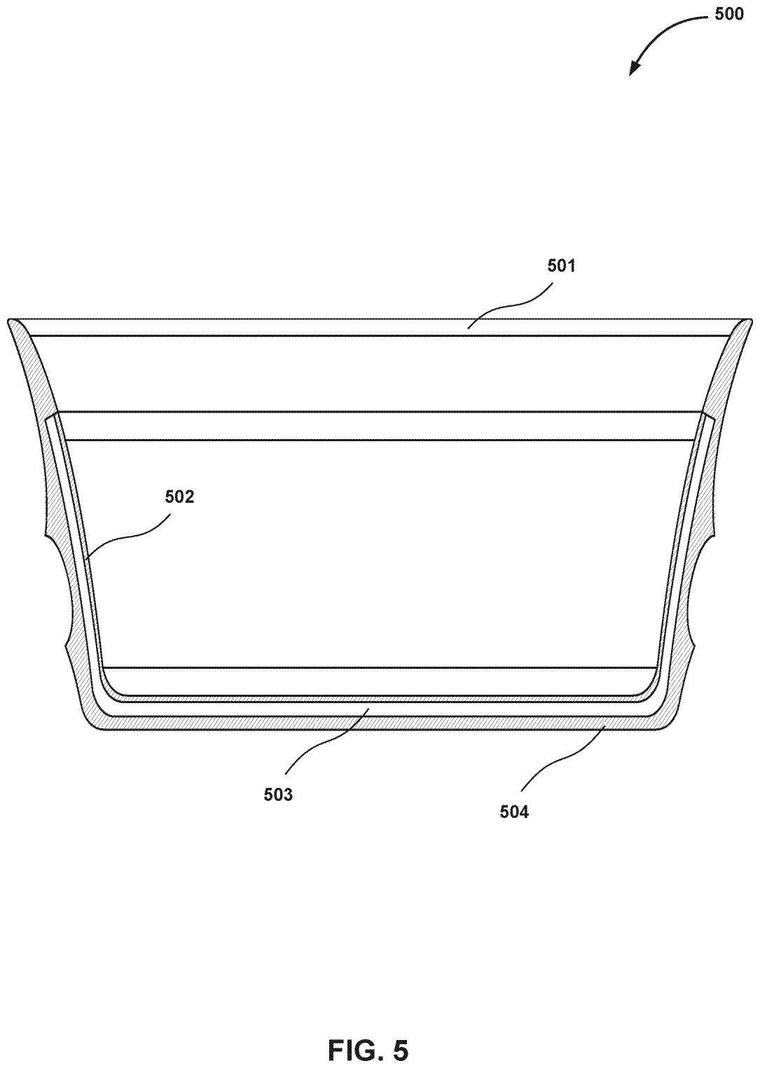

FIG. 5 is a diagram that illustrates a cross-sectional side view of a fourth cooking and tableware vessel 501, according to an exemplary embodiment of the present invention. As shown, the fourth cooking and tableware vessel 501 comprises an inner body layer 502 and an exterior body layer 504. There is an insulating layer 503 between the inner body layer 502 and the exterior body layer 504. The inner body layer 502 is a conductive layer. The exterior body layer 504 is an insulating layer. To produce heating for the food placed in the fourth cooking and tableware vessel 501, the conductive layer 502 is present above the insulating layer 503. The conductive layer 502 may be made of metal such as steel, iron, titanium, porcelainized iron, silver, copper, platinum, gold, aluminium, or the like. The conductive layer 502 can either be applied on a structural material such as ceramics or glass, or it can itself make up the structural material of the inner layer that is in contact with the food. The insulating layer 503 is placed between the conductive layer 502 and the outer surface 504 of the fourth cooking and tableware vessel 501. The insulating layer 503 may be made of materials with low heat conductivity like vacuum, aerogel, ceramic foam, glass foam, cork, air, or similar materials. The insulating layer 503 can either be an outer structural material or layer for the third cooking and tableware vessel 501, or there can be added an outer structural material such as the outer body layer 504 such that the insulating layer 503 is between the inner body layer 502 and the outer body layer 504 of the fourth cooking and tableware vessel 501. The insulating layer 503 may create a difference in heat that opens up the possibility to incorporate heat sensitive components either in or on the inner body layer 502 or the outer body layer 504.

A desired class of embodiments of the cooking and tableware vessel (as shown by 101 in FIG. 1, 301 in FIG. 3, 401 in FIG. 4, and 501 in FIG. 5) can be produced by a method of first producing two similar bodies in the shape of the desired cookware and tableware vessel. These represent the inner and outer body parts of the cooking and tableware vessel. The outer and inner bodies may have similar shape, while the outer body may be slightly bigger than the inner body, so that the outer body may encapsulate the inner body. To reduce the cost of production and presenting the user with a familiar tableware material, the outer body and the inner body may be made from at least one of glass, porcelain, earthware, stoneware, ceramic-glass, or a similar material. The selected material must withstand high temperatures and high temperature shocks. In a preferred version of the method for producing the cooking and tableware vessel, the two bodies are made out of borosilicate glass. Borosilicate glass is aesthetically pleasing and transparent, and it can resist large thermal shocks and has a high melting point. It is also less expensive than, for example, quartz glass. In the next step, a conductive layer is added to the outside surface of the inner body. This conductive layer may be painted or printed on the outside surface of the inner body. The conducive layer may be produced using at least a metal like silver, platinum, gold, copper, iron, aluminium, or a similar conductive material. In a preferred version of the method, fine silver powder may be mixed with an organic binder and then applied as a paste to the outside surface of the inner body. In this preferred version, the silver layer may be cured in an oven to burn off the organic binder and to form a permanent bond with the outer surface of the inner body. The thickness of the silver layer is usually around 30 to 100 microns. The thin conductive layer may produce heat when exposed to an alternating magnetic field. Typically, very conductive materials may fail to produce a lot of heat, however, given that the conductive layer is sufficiently thin, the stream of electrons may meet resistance due to the shallowness of the layer, and produce heat. The next step is to add an insulating layer made of at least one of aerogel, ceramic foam, glass foam, cork, air, or similar materials. The insulating layer is placed between the two bodies, and the thickness is usually in the range of 0.5 to 10 mm, depending on the material and the size of the cooking surface. A thinner insulation leads to electromagnetic fields that are stronger when they reach the conductive layer, while a thicker layer leads to less heat transfer. In a preferred version of the method, an air gap of about 1 to 3 mm is placed between the two bodies, after the inner body is placed inside the outer body. The next step is to weld, solder, or use any other method for bonding the two bodies together. In a preferred version of the method, the borosilicate bodies are welded together by applying heat and gently pushing the rim of the bodies together. The process produces a new body which has an outer wall (i.e., the outer body layer) and an inner wall (i.e., the inner body layer), with the insulative layer therebetween. In a preferred version of the method, the air gap is replaced by a vacuum by leaving a hole or cavity in the new body and applying a vacuum-pump to extract the air between the two walls. The hole is then sealed. The reason that it is important to first apply the conductive layer, is to make sure that the conductive layer can be fitted inside the new body. This has several benefits. The conductive layer is permanently fused to the tableware material; however, it is never in contact with the food. Further, the welding or soldering process leaves an airtight seal that makes the new body dishwasher safe and makes it possible to remove or add a gas for the purpose of increasing the insulation properties of the insulation layer.

Thus, the present invention discloses a dynamic, high frequency, magnetic induction field heating and serving vessel that can be used as a cookware, a tableware, or a food container. In general, one aspect of the disclosure features a cooking and tableware vessel (as shown in FIGS. 1-5) for use with an induction cooktop having a cooktop surface and an induction heating coil. The cooking utensil may comprise an inner wall comprising an electrically conductive material, an outer wall comprising an electrically non-conductive material, a gap between the inner and outer walls. Various implementations of the disclosure may include one or more of the following features. The cooking and tableware vessel may further comprise a layer of thermally insulating material positioned between the inner wall and the outer wall. The outer wall may define a bottom portion and the layer of thermally insulating material may have an area that substantially covers at least the bottom portion of the outer wall. The inner and outer walls may be spaced from one another except at a joint location where they are coupled The inner wall may define a bottom portion located closest to the cooktop surface during operation of the induction heating coil and a sidewall portion located farther from the cooktop surface during operation of the induction heating coil. The outer wall may define a bottom portion located on the cooktop surface during operation of the induction heating coil and a sidewall portion spaced above the cooktop surface during operation of the induction heating coil. The joint location may be proximate both the inner wall and the outer wall sidewall portions that are farthest from the cooktop surface when the bottom portion of the outer wall is located on the cooktop surface. The layer of thermally insulating material may define an outer edge closest to the sidewall portion of the outer wall, and an intermediate wall may be in contact with the layer of thermally insulating material proximate its outer edge.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims. Although particular embodiments of the invention have been described in detail for purposes of illustration, various modifications and enhancements may be made without departing from the spirit and scope of the invention. The scope of the invention is accordingly defined by the following claims.

What is claimed is:

1. An induction vessel, comprising:
an inner body layer that is configured to be a target for an induction heating coil,
an outer body layer, and
an insulating layer between the inner body layer and the outer body layer,
wherein the outer body layer is at a lower temperature in comparison to the inner body layer when the vessel is used as a cookware on an induction top, and accordingly the vessel is usable as a tableware or storage ware thereafter.

2. The induction vessel of claim 1, wherein the inner body layer is a conductive layer.

3. The induction vessel of claim 2, wherein, to produce heating of food placed in the vessel, the conductive layer is present above the insulating layer.

4. The induction vessel of claim 3, wherein the conductive layer is either applied on a structural material such as ceramics or glass, or it can itself make up the structural material of the inner body layer that is in contact with the food.

5. The induction vessel of claim 4, wherein the conductive layer is made of metal such as iron, steel, silver, gold, copper, or aluminum.

6. The induction vessel of claim 1, wherein the outer body layer is an insulating layer comprising an electrically non-conductive material.

7. The induction vessel of claim 1, wherein the insulating layer is made of one or more materials with low heat conductivity such as vacuum, aerogel, ceramic foam, glass foam, cork, or air.

8. The induction vessel of claim 1, wherein the insulating layer creates a difference in heat that opens up possibility to incorporate heat sensitive components either in or on the inner body layer or the outer body layer.

9. The induction vessel of claim 1, wherein, when the vessel is subjected to a magnetic field, the magnetic field quickly alternates which create eddy currents in the inner body layer.

10. The induction vessel of claim 9, wherein the magnetic field penetrates the outer body layer and the insulating layer to heat the inner body layer that is used for cooking.

11. The induction vessel of claim 1, wherein the vessel is usable as a teapot, an instant-food packaging box, a lunch box, a mug, a plate, a bowl, and a thermos bottle.

12. The induction vessel of claim 1, wherein the vessel is produced by a method by using glass, ceramic, or ceramic-glass.

13. The induction vessel of claim 12, wherein a first step of the method comprises producing an outer body and an inner body in a desired similar shape such that the outer body is slightly bigger than the inner body so that the outer body can encapsulate the inner body, wherein the outer body and the inner body are made by using a typical tableware material that is non-conductive and can resist high temperatures and thermal shocks, and wherein the material comprises at least one of borosilicate glass, quartz glass, porcelain, earthware, stoneware, ceramic-glass, or similar materials.

14. The induction vessel of claim 13, wherein a next step of the method comprises adding a metallic film to the outside layer of the inner body, wherein the metallic film is made of a conductive material or metal including at least one of silver, platinum, copper, iron, steel, graphene, or a similar material, wherein the film is added by mixing the metal in an organic binder, and then painting or printing the film onto the outside layer of the inner body, and wherein the film is cured in an oven to bind with the non-conductive surface of the inner body.

15. The induction vessel of claim 14, wherein the conductive film is very thin, and is often in a range of 30 micron to 1 mm.

16. The induction vessel of claim 14, wherein a next step of the method comprises placing the insulating layer between the outer body and inner body.

17. The induction vessel of claim 16, wherein the insulating layer is made of at least one of aerogel, ceramic foam, glass foam, cork, vacuum, or air.

18. The induction vessel of claim 16, wherein a next step of the method comprises creating a single body of the vessel by welding, soldering, or using similar splicing techniques to bond the inner body and the outer body together.

19. The induction vessel of claim 18, wherein a next step of the method comprises removing, if air has been previously used to insulate the vessel, the air by applying a vacuum-pump through a small hole or cavity in the single body,

20. The induction vessel of claim 19, wherein sealing the hole while under vacuum, creates a lasting-vacuum insulation between the two layers in the single new body.
